(19) United States
(12) Patent Application Publication
(10) Pub. No.: US 2023/0320320 A1
(43) Pub. Date: Oct. 12, 2023

(54) PET BOWL HANDLING DEVICE

(71) Applicants: Christina HAGLE, Simi Valley, CA (US); Susan K. EIGENBRODT, Sherman Oaks, CA (US)

(72) Inventors: Christina HAGLE, Simi Valley, CA (US); Susan K. EIGENBRODT, Sherman Oaks, CA (US)

(21) Appl. No.: 18/132,180

(22) Filed: Apr. 7, 2023

Related U.S. Application Data
(60) Provisional application No. 63/362,706, filed on Apr. 8, 2022.

(51) Int. Cl. A01K 5/01

(52) U.S. Cl. CPC A01K 5/0114

(57) ABSTRACT

A pet bowl handling device for grabbing, lifting, and manipulating a pet bowl that includes a handle extending upwardly away from a surface, a pet bowl collector including a sidewall extending downwardly away from a base, and a connector coupled to the handle and the pet bowl collector.

### CROSS-REFERENCE TO RELATED APPLICATIONS

This application claims the benefit of priority under 35 U.S.C § 119(e) to U.S. Provisional Patent Application Ser. No. 63/362,706, filed Apr. 8, 2022, which is herein incorporated by reference in its entity.

### FIELD OF DISCLOSURE

The present disclosure relates generally to pet bowl handling devices, and more specifically to pet bowl handling devices that grab, lift, and manipulate pet bowls.

### BACKGROUND

This disclosure refers to pet bowl handling devices, and in particular, to pet bowl handling devices that grab, lift, and manipulate pet bowls.

Devices that help pet owners or caretakers with moving pet bowls have been used for many years. Such devices include a mechanism to lift one or more pet bowls off the ground with a handle. Such devices, however, require the pet owner or caretaker to place the pet bowl by hand in or on the device before moving the bowl and/or remove the pet bowl by and in or on the device before moving the bowl once the bowl has been moved. This may include requiring the pet owner or caretaker to bend over to access the pet bowl, which could cause pain or discomfort to the pet owner or caretaker. Some of these devices require the device to be left in place while the pet eats or drinks from the bowl, running the risk of the device being knocked over and injuring the pet, the owner or caretaker, or causing the or water in the bowl to be spilled. It is an object of the present disclosure to provide a pet bowl handling device that allows the pet owner or caretaker to grab, lift, and manipulate the pet bowl without the user having to bend over and without attaching the device to or leaving the device with the pet bowl.

### SUMMARY

The present disclosure may comprise one or more of the following features and combinations thereof.

According to an illustrative aspect of the present disclosure, a pet bowl handling device includes a handle, a pet bowl collector, and a connector. The handle extends upwardly away from a surface. The connector is coupled to the handle and the pet bowl collector.

The pet bowl collector has a sidewall and a base. The sidewall extends downwardly away from the base. The base has a cutout. The cutout has a width greater than an outer width of a body of the pet bowl and lesser than an outer width of a lip of the pet bowl. The cutout allows the pet bowl collector to engage and disengage the pet bowl. The cutout also allows the lip of the pet bowl to rest on an upper surface of the base when a user lifts the pet bowl away from the surface using the pet bowl handling device.

In some embodiments, the cutout is an arcuate cutout. In some embodiments, the base includes more than one cutout. In some embodiments, the connector includes an upper bridging member and at least one downwardly extending attachment member. In some embodiments, the upper bridging member is coupled to the handle and the at least one downwardly extending attachment member is coupled to an outer edge of the sidewall and the base of the pet bowl collector. In some embodiments, the handle includes a grip. In some embodiments, the handle, the connector, and the pet bowl collector are integrally formed from one sheet of metal.

According to another illustrative aspect of the present disclosure, a pet bowl handling device includes a handle and a pet bowl collector coupled to the handle. The pet bowl collector includes a base, and the base includes a cutout and an upper surface. The cutout has a width greater than an outer width of a body of the pet bowl and lesser than an outer width of a lip of the pet bowl. The upper surface engages the lip of the pet bowl to allow the lip of the pet bowl to rest on the upper surface when a user lifts the pet bowl away from the surface using the pet bowl handling device.

In some embodiments, the cutout is an arcuate cutout. In some embodiments, the base includes more than one cutout. In some embodiments, the pet bowl handling device further includes a connector coupled to the handle and the pet bowl collector. In some embodiments, the connector includes an upper bridging member and at least one downwardly extending attachment member. In some embodiments, the upper bridging member is coupled to the handle and the at least one downwardly extending attachment member is coupled to the sidewall and the base of the pet bowl collector. In some embodiments, the handle includes a grip. In some embodiments, the handle and the pet bowl collector are integrally formed from one sheet of metal. In some embodiments, the handle, the connector, and the pet bowl collector are integrally formed from one sheet of metal.

According to an additional illustrative aspect of the present disclosure, a method for manipulating a pet bowl with a pet bowl handling device includes the a first step of aligning the pet bowl handling device with the pet bowl positioned on a surface. The pet bowl handling device includes a handle and a a pet bowl collector having a base. The base includes a cutout and an upper surface. The cutout has a width greater than an outer width of a body of the pet bowl and lesser than an outer width of a lip of the pet bowl. The method includes a second step of moving the pet bowl handling device towards the pet bowl until the cutout of the pet bowl collector engages the body of the pet bowl. The method includes a third step of lifting the pet bowl handling device away from the surface so that the upper surface engages the lip of the pet bowl to allow the pet bowl to be removed from the surface.

In some embodiments, the method further includes a step of aligning the pet bowl over a second surface. In some embodiments, the method further includes a step of lowering the pet bowl handling device until the pet bowl is positioned on the second surface. In some embodiments, the method further includes a step of moving the pet bowl handling device away from the pet bowl to disengage the pet bowl collector from the pet bowl.

These and other features of the present disclosure will become more apparent from the following description of the illustrative embodiments.

### BRIEF DESCRIPTION OF THE DRAWINGS

FIG. 1 is a perspective view of a pet bowl handling device comprising a pet bowl collector, a connector, and a handle configured to engage a pet bowl;

FIG. 2 is a perspective view of the pet bowl handling device of FIG. 1 showing the pet bowl collector engaged with the pet bowl;

FIG. 3 is a perspective view of the pet bowl handling device of FIG. 2 showing the pet bowl handling device and the pet bowl lifted upwardly relative to a floor;

FIG. 4 is a top view of the pet bowl handling device of FIG. 1;

FIG. 5 is a side view of the pet bowl handling device of FIG. 2 and FIG. 3 showing the pet bowl collector engaged with the pet bowl.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

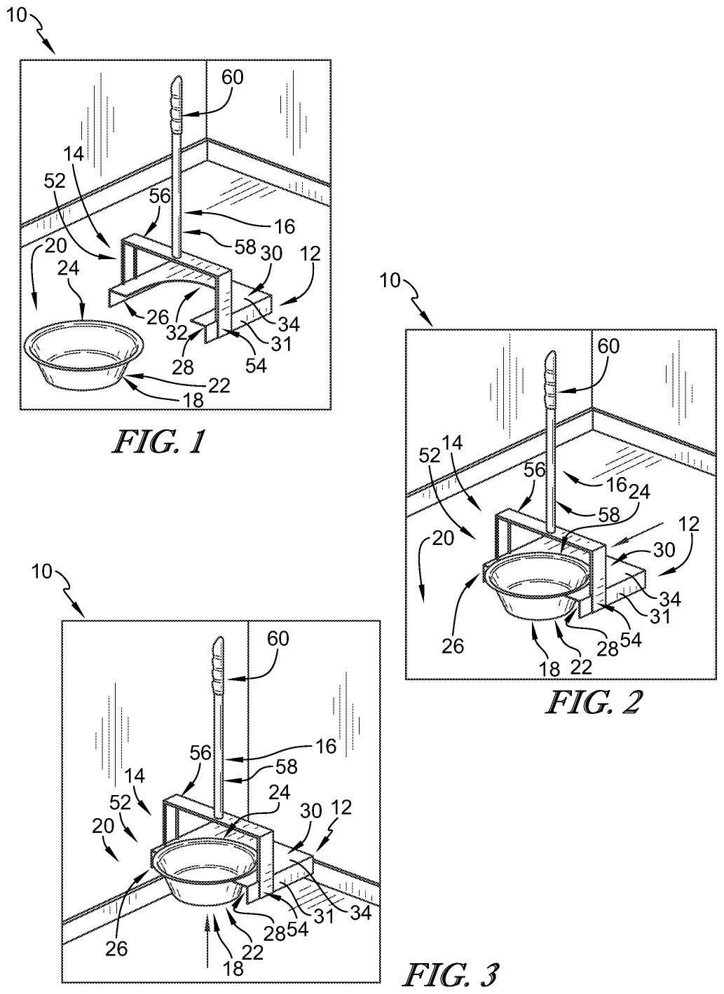

An illustrative pet bowl handling device 10 is shown in FIGS. 1-3, which includes a pet bowl collector 12, a connector 14, and a handle 16. The pet bowl handling device 10 is configured to grab, lift, manipulate, move, and/or position a pet bowl 18 from and/or on a surface 20, such as a floor 20. The pet bowl 18 may be any pet bowl which has a body 22 and a lip 24. The pet bowl collector 12 is configured to engage, and/or hold the pet bowl 18. The connector 14 is coupled between the pet bowl collector 12 and the handle 16. The handle 16 allows a user to move the pet bowl handling device 10 to lift, move, rotate and/or otherwise place the pet bowl 18. The pet bowl collector 12, the connector 14, and the handle 16 may comprise of any metal, alloy, plastic, wood, or any combination of materials suitable for the present disclosure. In alternative embodiments, the pet bowl collector 12, the connector 14, and the handle 16 may be integrally formed from one sheet of metal or another material. In some embodiments, the pet bowl handling device 10 may include only a pet bowl collector 12 and a handle 16. In other embodiments, the pet bowl handling device 10 may include only a pet bowl collector 12 and a connector 14.

The pet bowl collector 12 includes side walls 26, 28 and a base 30, as shown in FIGS. 1-3. The side walls 26, 28 support the base 30. While the illustrative embodiment shows the base 30 and the side walls 26, 28 forming a generally rectangular shape, any desired shape may be used on the base 30 and/or the side walls 26, 28. Likewise, the pet bowl collector 12 may have less than or more than two side walls 26, 28. For example, the pet bowl collector 12 may have three side walls. Furthermore, in the illustrative embodiment, the side walls 26, 28 and the base 30 have the same thickness. In other embodiments, however, the side walls 26, 28 and the base 30 may have different thicknesses. The side walls 26, 28 may be any height. In the illustrative embodiment, the side walls 26, 28 and the base 30 are welded together. In other embodiments, however, the side walls 26, 28 and the base 30 may be coupled together with adhesive, screws, nails, or any other method capable of securing the side walls 26, 28 to the base 30. In some embodiments, the side walls and the base may be integrally formed from one sheet of metal or another material. In other embodiments, the pet bowl collector 12 may be only the base 30. Each of the side walls 26, 28 include an outer surface 31.

Referring to FIGS. 1-5, the base 30 includes a cutout 32 and an upper surface 34. The cutout 32 is configured to engage and disengage the pet bowl 18. The upper surface 34 is configured to engage the lip 24 of the pet bowl 24 to allow the lip 24 to rest on the upper surface 34 when a user lifts the pet bowl 18 away from the floor 20 using the pet bowl handling device 20.

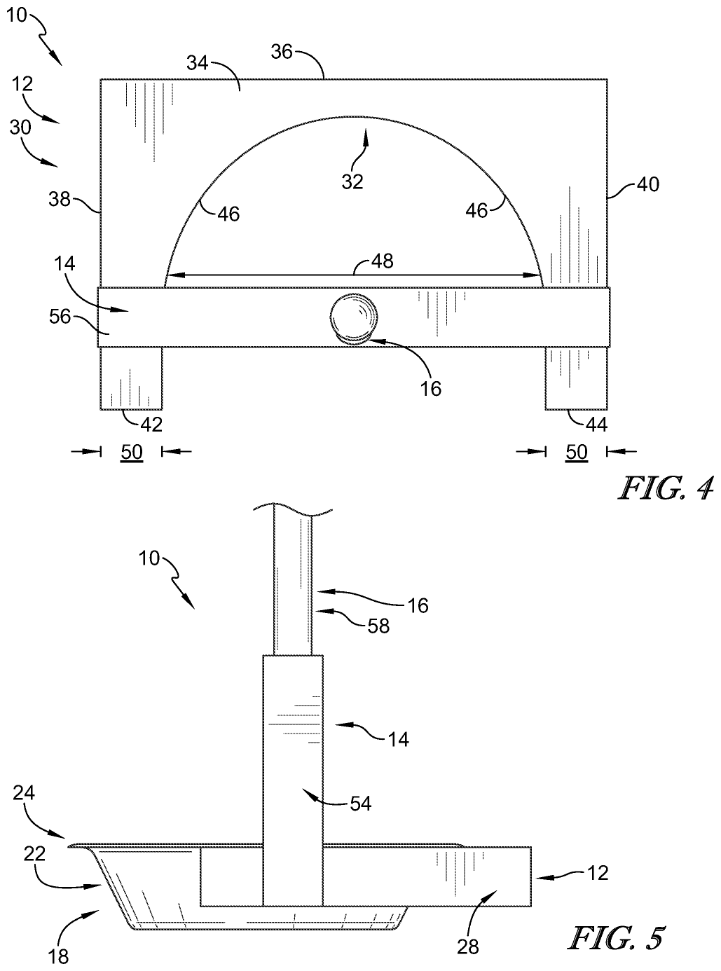

The upper surface includes a back edge 36, side edges 38, 40, front edges 42, 44, and a cutout edge 46, as shown in FIG. 4. The back edge 36 is parallel to the two front edges 42, 44. The side edges 38, 40, extend between the back edge 36 and the front edges 42, 44. The front edges 42, 44 are separated by the cutout edge 46. The cutout edge 46 connects the front edges 42, 44 and extends towards the back edge 36 to form the cutout 32. The cutout edge 46 and the cutout 32 in the illustrative embodiment are arcuate, as shown in FIG. 4, to accommodate a circular pet bowl 18. In other embodiments, however, the cutout edge 46 and the cutout 32 may be shaped to accommodate any shape of pet bowl 18. A width 48 of the arcuate cutout edge 46 and the cutout 32 is sized to be greater than a maximum outer diameter of the body 22 of the pet bowl 18 and less than an outer diameter of the lip 24 of the pet bowl 18. In the illustrative embodiment, the front edges 42, 44 are a same length 50 such that the cutout 32 is centered on the base 30. In other embodiments, front edges 42, 44 may be different lengths. In some embodiments, the base 30 may have more than or less than two side edges 38, 40 and/or more than or less than two front edges 42, 44. Additionally or alternatively, the base 30 may have more than one cutout edge 46 to form more than one cutout 32.

The connector 14 includes downwardly extending attachment members 52, 54 and a bridging member 56, as shown in FIGS. 1-3. The downwardly extending attachment members 52, 54 are coupled to the pet bowl collector 12. In the illustrative embodiment, each of the downwardly extending attachment members 52, 54 are connected (e.g. via a weld) to both the base 30 and the sidewalls 26, 28 of the pet bowl collector 12. In other embodiments, the downwardly extending attachment members 52, 54 may be coupled to the base 30 and/or the sidewalls 26, 28 with adhesive, screws, nails, or any other method capable of securing the downwardly extending attachment members 52, 54 to the pet bowl collector 12. The upper bridging member 56 is coupled to each of the downwardly extending attachment members 52, 54 and the handle 16. In the illustrative embodiment, the upper bridging member 56 is generally parallel relative to the base 30, and the downwardly extending attachment members 50, 52 are generally perpendicular to the base 30. In other embodiments, however, the downwardly extending attachment members 52, 54 and/or the upper bridging member 56 may be in different orientations forming different angles.

The connector 14 may have more than or less than two downwardly extending attachment members 52, 54. The downwardly extending attachment members 52, 54 may be any height which allows the distance between the upper bridging member 56 and the upper surface 34 to be greater than the thickness of the pet bowl lip 24. In alternative embodiments, the connector 14 may not have an upper bridging member 56, and instead the downwardly extending attachment members 52, 54 may be coupled to the pet bowl collector 12, each other, and the handle 16.

In the illustrative embodiment, the upper bridging member 56 is welded to both downwardly extending attachment members 52, 54 and the handle 16, as shown in FIGS. 1-3. In other embodiments, the upper bridging member 56 may be coupled to the downwardly extending attachment members 52, 54 and/or the handle 16 with adhesive, screws, nails, or any other method capable of securing the upper bridging member 56 to the downwardly extending attachment members 52, 54 and/or the handle 16. In some embodiments, the upper bridging member 56 and the downwardly extending attachment members 52, 54 may be integrally formed from one sheet of metal or another material.

The handle 16 includes a rod 58 and a grip 60, as shown in FIGS. 1-3. The rod 58 is coupled to the upper bridging member 56. In the illustrative embodiment, the rod 58 extends generally vertically relative to the upper bridging member 56 and the base 30. In other embodiments, the rod 58 may not extend generally vertically relative to the upper bridging member 56 and the base 30. In some embodiments, the handle 16 may have more than one rod 58. The grip 60 is hollow and extends over and wraps around the rod 58. In other embodiments, the grip 60 may not be hollow. In the illustrative embodiment, the grip 60 is rubber. In other embodiments, the grip 60 may be the same material as the rod 58, plastic, or any other suitable material. In some embodiments, the handle 16 may not have a grip 60. In the illustrative embodiment, the grip 60 is removable from the rod 58. In other embodiments, the grip 60 may be integrally coupled to the rod 58, such as by adhesive or any other method of securing the grip 60 to the rod 58. In some embodiments, the grip 60 and the rod 58 may be one integrated or unitary with one another.

Referring to FIGS. 1-3, an illustrative method for manipulating the pet bowl 18 with the pet bowl handling device 10 may be utilized. First, a user aligns the cutout 32 with the pet bowl 18. Then, the user moves the pet bowl handling device 10 towards the pet bowl 18 until the pet bowl collector 12 engages the body 22 of the pet bowl 18, as shown in FIG. 2. Finally, the user lifts the pet bowl handling device 10 away from the surface 20 to allow the lip 24 of the pet bowl 18 to rest on the upper surface 34. Lifting the pet bowl handling device 10 may also include removing the pet bowl 18 from the surface 20.

The method of manipulating the pet bowl 18 may also include the steps of aligning the pet bowl 18 over a second surface with the pet bowl handling device 10, lowering the pet bowl handling device 10 until the pet bowl 18 is positioned on the surface 20 or other surface, and/or moving the pet bowl handling device 10 away from the pet bowl 18 to disengage the pet bowl collector 12 from the pet bowl 18. The second surface may be a surface separate from the surface 20, or the second surface may be the surface 20. It should be appreciated that the pet bowl handling device 10 of the illustrative method may be any combination of elements as described above. For example, the pet bowl collector 12 may have more than one cutout 32 to manipulate more than one pet bowl 12.

In some embodiments, the pet bowl 12 is a food bowl. In other embodiments, the pet bowl 12 is a water bowl.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A pet bowl handling device comprising:
a handle extending upwardly away from a surface,
a pet bowl collector including a sidewall and a base, and
a connector coupled to the handle and the pet bowl collector,
wherein the sidewall extends downwardly away from the base, and
wherein the base includes a cutout having a width greater than an outer width of a body of a pet bowl and lesser than an outer width of a lip of the pet bowl to allow the pet bowl collector to engage and disengage the pet bowl and to allow the lip of the pet bowl to rest on the base when a user lifts the pet bowl away from the surface using the pet bowl handling device.

2. The pet bowl handling device of claim 1, wherein the cutout is an arcuate cutout.

3. The pet bowl handling device of claim 1, wherein the base includes more than one cutout.

4. The pet bowl handling device of claim 1, wherein the connector includes an upper bridging member and at least one downwardly extending attachment member.

5. The pet bowl handling device of claim 4, wherein the upper bridging member is coupled to the handle and the at least one downwardly extending attachment member is coupled to an outer edge of the sidewall and the base of the pet bowl collector.

6. The pet bowl handling device of claim 1, wherein the handle includes a grip.

7. The pet bowl handling device of claim 1, wherein the handle, the connector, and the pet bowl collector are integrally formed from one sheet of metal.

8. A pet bowl handling device comprising:
a handle,
a pet bowl collector including a base, wherein the base includes a cutout and an upper surface, wherein the pet bowl collector is coupled to the handle,
wherein the cutout has a width greater than an outer width of a body of a pet bowl and lesser than an outer width of a lip of the pet bowl,
wherein the upper surface engages the lip of the pet bowl to allow the lip of the pet bowl to rest on the upper surface when a user lifts the pet bowl away from a surface using the pet bowl handling device.

9. The pet bowl handling device of claim 8, wherein the cutout is an arcuate cutout.

10. The pet bowl handling device of claim 8, wherein the base includes more than one cutout.

11. The pet bowl handling device of claim 8, further comprising a connector coupled to the handle and the pet bowl collector.

12. The pet bowl handling device of claim 11, wherein the connector includes an upper bridging member and at least one downwardly extending attachment member.

13. The pet bowl handling device of claim 12, wherein the upper bridging member is coupled to the handle and the at least one downwardly extending attachment member is coupled to the sidewall and the base of the pet bowl collector.

14. The pet bowl handling device of claim 8, wherein the handle includes a grip.

15. The pet bowl handling device of claim 8, wherein the handle and the pet bowl collector are integrally formed from one sheet of metal.

16. The pet bowl handling device of claim 11, wherein the handle, the connector, and the pet bowl collector are integrally formed from one sheet of metal.

17. A method for manipulating a pet bowl with a pet bowl handling device comprising the steps of:
aligning the pet bowl handling device with the pet bowl positioned on a surface, the pet bowl handling device including a handle and a pet bowl collector having a base, wherein the base includes a cutout and an upper surface, the cutout having a width greater than an outer width of a body of the pet bowl and lesser than an outer width of a lip of the pet bowl,
moving the pet bowl handling device towards the pet bowl until the cutout of the pet bowl collector engages the body of the pet bowl,
lifting the pet bowl handling device away from the surface, wherein the upper surface engages the lip of the pet bowl to allow the pet bowl to be removed from the surface.

18. The method of claim 17, further comprising a step of aligning the pet bowl over a second surface.

19. The method of claim 18, further comprising a step of lowering the pet bowl handling device until the pet bowl is positioned on the second surface.

20. The method of claim 19, further comprising a step of moving the pet bowl handling device away from the pet bowl to disengage the pet bowl collector from the pet bowl.
